(19) United States
(12) Patent Application Publication
(10) Pub. No.: US 2020/0311622 A1
(43) Pub. Date: Oct. 1, 2020

(54) MANAGEMENT DEVICE, MANAGEMENT METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Ryoma Taguchi, Tokyo (JP); Yuta Takada, Tokyo (JP)

(21) Appl. No.: 16/822,088

(22) Filed: Mar. 18, 2020

(30) Foreign Application Priority Data
Mar. 29, 2019 (JP) 2019-066190

(51) Int. Cl. G06Q 10/02; G06Q 20/08; G06Q 10/06; B60L 53/36

(52) U.S. Cl. CPC G06Q 10/02; G06Q 20/085; G05D 1/0088; B60L 53/36; G06Q 2240/00; G06Q 10/06315

(57) ABSTRACT

A management device includes a receiver configured to receive reservation information, on the basis of an operation of a user, in which vehicle identification of a vehicle scheduled to park in a parking lot is associated with a parking start time at which the vehicle scheduled to park starts parking, and an information processor configured to refer to permission information in which identification information of a parking vehicle parking in the parking lot is associated with time for which the parking vehicle is permitted to park in the parking lot, and the reservation information, and to give a penalty to a user of the parking vehicle when the parking vehicle has parked in the parking lot beyond the time in a state in which a reservation of the vehicle scheduled to park is present.

### CROSS-REFERENCE TO RELATED APPLICATION

Priority is claimed on Japanese Patent Application No. 2019-066190, filed Mar. 29, 2019, the content of which is incorporated herein by reference.

### BACKGROUND

### Field

The present invention relates to a management device, a management method, and a storage medium.

### Description of Related Art

Conventionally, a parking lot reservation management device which determines whether there is an overlap between a reserved entrance time and a reserved use time of a reserved vehicle and a scheduled entrance time and a scheduled use time according to a reservation request, and determines whether the reservation request can be received has been disclosed (Japanese Unexamined Patent Application, First Publication No. H9-16898).

However, when a vehicle has parked in a parking lot beyond a reserved time, the reserved vehicle may not be able to park in the parking lot. In such a case, an operation efficiency of the parking lot may be reduced.

### SUMMARY

The present invention has been made in view of such circumstances, and an object thereof is to provide a management device, a management method, and a storage medium that can improve the operation efficiency of a parking lot.

The management device, the management method, and the storage medium according to the present invention have adopted the following configuration.

(1): A management device according to one aspect of the present invention is a management device which includes a receiver configured to receive reservation information, on the basis of an operation of a user, in which vehicle identification of a vehicle scheduled to park in a parking lot is associated with a parking start time at which the vehicle scheduled to park will start parking, and an information processor configured to refer to permission information in which identification information of a parking vehicle parking in the parking lot is associated with a time for which the parking vehicle is permitted to park in the parking lot, and the reservation information, and to give a penalty to a user of the parking vehicle when the parking vehicle has parked in the parking lot beyond the time in a state in which a reservation of the vehicle scheduled to park is present.

(2): In the aspect of (1) described above, the parking lot is a parking lot in which the parking vehicle and the vehicle scheduled to park are permitted to park using autonomous entrance or to exit from the parking lot using autonomous exit.

(3): In the aspect of (1) or (2) described above, the information processor is configured to give a reward to a user of the vehicle scheduled to park when the vehicle scheduled to park cannot park in the parking lot at the parking start time.

(4): In the aspects of (1) to (3) described above, when the vehicle scheduled to park cannot park in the parking lot at the parking start time, the information processor is configured to instruct the vehicle scheduled to park to park in a parking space for electric vehicles, which is equipped with a charging facility.

(5): In the aspect of (4) described above, when the vehicle scheduled to park is instructed to park in the parking space for electric vehicles, the information processor is configured to refer to information regarding the vehicle scheduled to park with which a type of the vehicle scheduled to park is associated, and allows the vehicle scheduled to park to use the charging facility for free when the vehicle scheduled to park is an electric vehicle.

(6): In the aspect of any one of (1) to (5) described above, when the vehicle scheduled to park cannot park in the parking lot at the parking start time, the information processor does not give a penalty to the user of the parking vehicle when information indicating that the parking vehicle will park in the parking lot beyond the permitted time is acquired before the permitted time elapses.

(7): In the aspect of any one of (1) to (6) described above, the information processor provides a terminal of the user of the parking vehicle with information indicating that an end time is approaching predetermined time before the end time of the permitted time for parking.

(8): In the aspect of any one of (1) to (7) described above, the information processor is configured to give a reward to the user of the vehicle scheduled to park when the vehicle scheduled to park cannot park in the parking lot due to a reason not caused by the parking vehicle.

(9): In the aspect of (8) described above, the reason not caused by the parking vehicle is that the management device has received parking reservations from a larger number of vehicles than the number of vehicles that are acceptable by the parking lot at a time at which the vehicle scheduled to park starts parking, or is a defect of the management device.

(10): A management method according to another aspect of the present invention is a management method which includes, by a computer, receiving reservation information, on the basis of an operation of a user, in which vehicle identification of a vehicle scheduled to park in a parking lot is associated with a parking start time at which the vehicle scheduled to park starts parking, referring to permission information in which identification information of a parking vehicle parking in the parking lot is associated with time for which the parking vehicle is permitted to park in the parking lot, and the reservation information, and giving a penalty to a user of the parking vehicle when the parking vehicle has parked in the parking lot beyond the time in a state in which a reservation of the vehicle scheduled to park is present.

(11): A non-transitory computer-readable storage medium that stores a computer program to be executed by a computer to perform at least: receiving reservation information, on the basis of an operation of a user, in which vehicle identification of a vehicle scheduled to park in a parking lot is associated with a parking start time at which the vehicle scheduled to park starts parking, referring to permission information in which identification information of a parking vehicle parking in the parking lot is associated with time for which the parking vehicle is permitted to park in the parking lot, and the reservation information, and giving a penalty to a user of the parking vehicle when the parking vehicle has parked in the parking lot beyond the time in a state in which a reservation of the vehicle scheduled to park is present.

According to (1), (2), (4), (9), (10), and (11), it is possible to improve an operation efficiency of the parking lot.

According to (3) and (8), the management device is configured to give a reward to the user of the vehicle scheduled to park, thereby improving a sense of agreement of the user.

According to (5), since the vehicle scheduled to park can use the charging facility for free, the management device can improve the sense of agreement of the user or improve a degree of satisfaction.

According to (6), since the management device does not give a penalty to the user when there is a prior contact, convenience of the user can be improved.

According to (7), the management device provides the user with information indicating that an exit time is approaching, thereby improving the convenience of the user.

### BRIEF DESCRIPTION OF THE DRAWINGS

FIG. 1 is a configuration diagram of a parking lot management system including a vehicle system.

FIG. 2 is a diagram which shows an example of a functional configuration of the vehicle system.

FIG. 3 is a functional configuration diagram of a first controller and a second controller.

FIG. 4 is a diagram which schematically shows a scene in which an autonomous parking event is executed.

FIG. 5 is a diagram which shows an example of a configuration of a parking lot management device.

FIG. 6 is a diagram which shows an example of a functional configuration of a reservation management device.

FIG. 7 is a diagram which shows an example of content of use management information.

FIG. 8 is a flowchart which shows an example of a flow of processing executed by the reservation management device and a terminal device.

FIG. 9 is a diagram which shows an example of content of reservation management information.

FIG. 10 is a flowchart which shows an example of a flow of processing executed by the reservation management device.

FIG. 11 is a diagram which shows an example of content of user information.

FIG. 12 is a diagram which shows an example of a hardware configuration of an automated driving control device according to the embodiment.

### DETAILED DESCRIPTION

Hereinafter, embodiment of a management device, a management method, and a storage medium of the present invention will be described with reference to the drawings.

### First Embodiment

### Overall Configuration

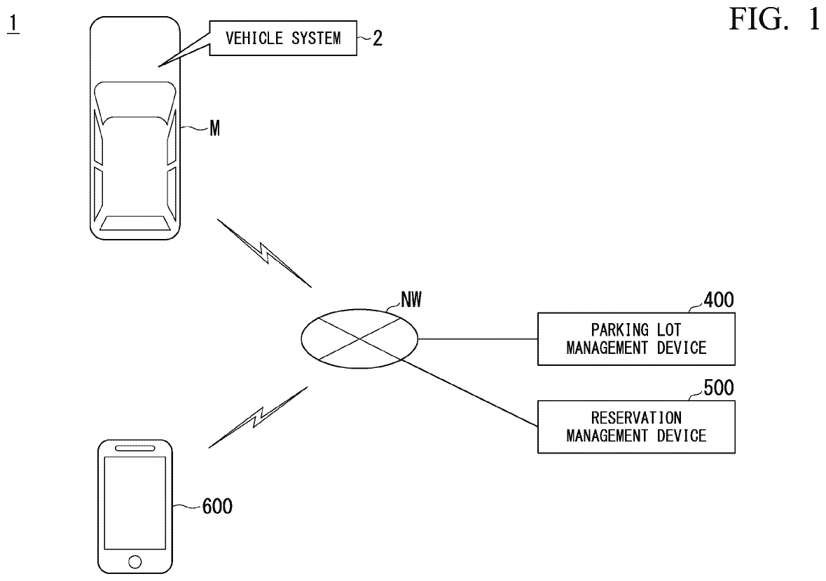

FIG. 1 is a configuration diagram of a parking lot management system 1 including a vehicle system 2. The parking lot management system 1 includes, for example, one or more vehicles (hereinafter, a host vehicle M) equipped with the vehicle system 2, one or more parking lot management devices 400, one or more reservation management devices 500, and one or more terminal devices 600. These components can communicate with each other via a network NW. The network NW includes a cellular network, a Wi-Fi network, the Internet, a wide area network (WAN), a local area network (LAN), a public line, a provider device, a dedicated line, a wireless base station, and the like. Each of these components may directly perform wireless communication without going through the network NW. Details of the host vehicle M, the parking lot management device 400, the reservation management device 500, and the terminal device 600 will be described below.

The terminal device 600 is, for example, a terminal device that can be carried by a user, such as a smartphone, a tablet terminal, and a personal computer. The terminal device 600 communicates with the host vehicle M, and transmits a request of the user to the host vehicle M or performs push notification based on information received from the host vehicle M or the parking lot management device 400. The terminal device 600 communicates with the reservation management device 500 and makes an reservation for parking the host vehicle M in a predetermined parking lot.

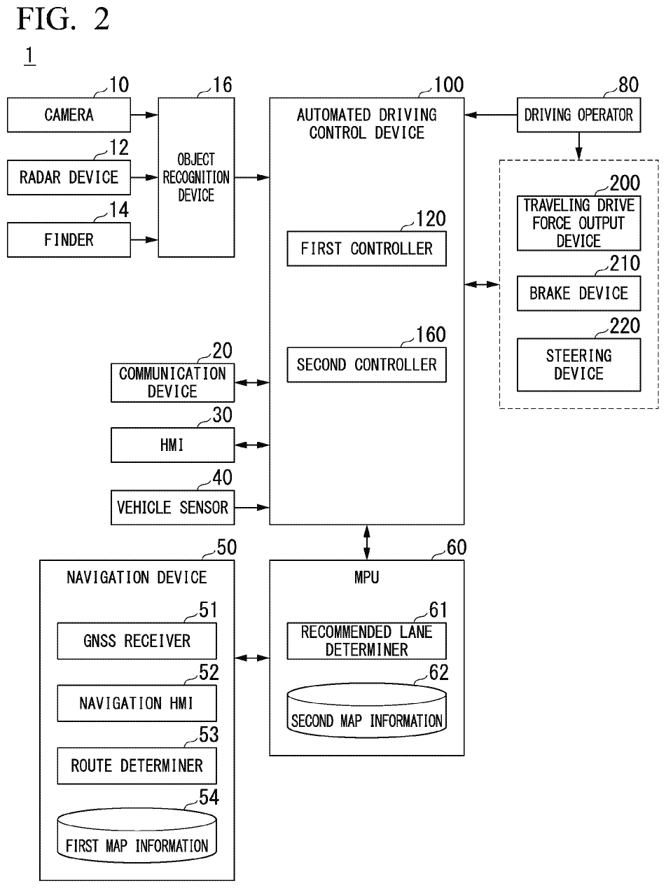

FIG. 2 is a diagram which shows an example of a functional configuration of the vehicle system 2. A vehicle on which the vehicle system 2 is mounted is, for example, two-wheel, three-wheel, or four-wheel vehicle, and a driving source thereof is an internal combustion engine such as a diesel engine or a gasoline engine, an electric motor, or a combination thereof. The electric motor operates using electric power generated by a generator connected to the internal combustion engine, or electric power discharged from a secondary battery or a fuel cell.

The vehicle system 2 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a traveling drive force output device 200, a brake device 210, and a steering device 220. These devices or apparatuses are connected to each other by a multiplex communication line such as a controller area network (CAN) communicator line, a serial communication line, a wireless communication network, or the like. The configuration shown in FIG. 2 is merely an example, and a part of the configuration may be omitted or another configuration may be added.

The camera 10 is, for example, a digital camera using a solid-state imaging device such as a charge coupled device (CCD) or a complementary metal oxide semiconductor (CMOS). The camera 10 is attached to an arbitrary position of a vehicle (hereinafter, a host vehicle M) on which the vehicle system 2 is mounted. The vehicle system 2 includes, for example, a plurality of cameras 10. The camera 10 is attached to, for example, an upper part of the front windshield, a rear surface of the rear view mirror, or the like, and captures an image of the front of the vehicle. The camera 10 is attached to, for example, an upper part of a rear windshield, near a license plate on a rear outside of the vehicle, or near a trunk door on the rear outside of the vehicle, and captures an image of the rear of the vehicle. The camera 10 periodically and repeatedly captures images of a vicinity of the host vehicle M. The camera 10 may also be a stereo camera.

The radar device 12 radiates radio waves such as millimeter waves to the vicinity of the host vehicle M, and detects at least a position (a distance and an orientation) of an object by detecting radio waves (reflected waves) reflected by the object. The radar device 12 is attached to an arbitrary part of the host vehicle M. The radar device 12 may detect the position and a speed of the object using a frequency modulated continuous wave (FM-CW) method.

The finder 14 is a light detection and range (LIDAR). The finder 14 radiates light to the vicinity of the host vehicle M and measures scattered light. The finder 14 detects a distance to the target on the basis of time from light emission and light reception. The radiated light is, for example, pulsed laser light. The finder 14 is attached to an arbitrary place of the host vehicle M.

The object recognition device 16 performs sensor fusion processing on a result of detection performed by some or all of the camera 10, the radar device 12, and the finder 14, and recognizes the position, type, speed, and the like of the object. The object recognition device 16 outputs a result of the recognition to the automated driving control device 100. The object recognition device 16 may output the results of detection by the camera 10, the radar device 12, and the finder 14 to the automated driving control device 100 as they are. The object recognition device 16 may be omitted from the vehicle system 2.

The communication device 20 uses, for example, a cellular network, a Wi-Fi network, a Bluetooth (a registered trademark), a dedicated short range communication (DSRC), or the like, and communicates with another vehicle or a parking lot management device (to be described below) present in the vicinity of the host vehicle M or various types of server devices.

The HMI 30 presents various types of information to an occupant of the host vehicle M and receives an input operation from the occupant. The HMI 30 includes various display devices, speakers, buzzers, touch panels, switches, keys, and the like.

The vehicle sensor 40 includes a vehicle speed sensor that detects the speed of the host vehicle M, an acceleration sensor that detects the acceleration, a yaw rate sensor that detects an angular speed around a vertical axis, an orientation sensor that detects a direction of the host vehicle M and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M on the basis of a signal received from a GNSS satellite. The position of the host vehicle M may be identified or supplemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route (hereinafter, a route on a map) from the position (or an arbitrary input position) of the host vehicle M identified by the GNSS receiver 51 to a destination input from the occupant using the navigation HMI 52 with reference to the first map information 54. The first map information 54 is, for example, information in which a road shape is expressed by a link indicating a road and a node connected by the link. The first map information 54 may include curvature of a road, point of interest (POI) information, and the like. The route on a map is output to the MPU 60. The navigation device 50 may perform route guidance using the navigation HMI 52 on the basis of the route on a map. The navigation device 50 may be realized by, for example, a function of a terminal device such as a smart phone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in the storage device such as an HDD or a flash memory. The recommended lane determiner 61 divides the route on a map provided from the navigation device 50 into a plurality of blocks (for example, divides every 100 [m] in a vehicle traveling direction), and determines a recommended lane for each block with reference to the second map information 62. The recommended lane determiner 61 determines which numbered lane to travel from the left. When there is a branch point in the route on a map, the recommended lane determiner 61 determines a recommended lane such that the host vehicle M travels in a reasonable route for traveling to a branch destination.

The second map information 62 is map information with higher accuracy than the first map information 54. The second map information 62 includes, for example, information on a center of a lane or information on a boundary of the lane. The second map information 62 may include road information, traffic regulation information, address information (addresses/postal codes), facility information, telephone number information, and the like. The second map information 62 may be updated at any time by the communication device 20 communicating with another device.

The driving operator 80 includes, for example, an accelerator pedal, a brake pedal, a shift lever, a steering wheel, a modified steer, a joystick, and other operators. A sensor that detects an operation amount or a presence or absence of an operation is attached to the driving operator 80, and this detection result is output to the automated driving control device 100 or some or all of the traveling drive force output device 200, the brake device 210, and the steering device 220.

The automated driving control device 100 includes, for example, a first controller 120 and a second controller 160. Each of the first controller 120 and the second controller 160 is realized, for example, by a hardware processor such as a central processing unit (CPU) executing a program (software). Some or all of these components may be realized by hardware (a circuit; including circuitry) such as a large scale integration (LSI), an application specific integrated circuit (ASIC), a field-programmable gate array (FPGA), and a graphics processing unit (GPU), and may also be realized by a cooperation of software and hardware. The program may be stored in advance in a storage device (a storage device including a non-transitory storage medium) such as an HDD or a flash memory of the automated driving control device 100, or may be stored in a detachable storage medium such as a DVD or a CD-ROM and installed in the HDD or the flash memory of the automated driving control device 100 by the storage medium (the non-transitory storage medium) being mounted on a drive device.

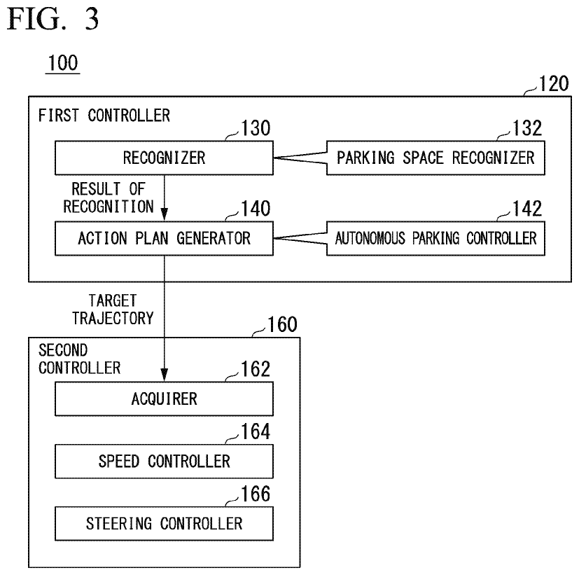

FIG. 3 is a functional configuration diagram of the first controller 120 and the second controller 160. The first controller 120 includes, for example, a recognizer 130 and an action plan generator 140. The first controller 120 realizes, for example, a function based on artificial intelligence (AI) and a function based on a model given in advance in parallel. For example, a function of “recognizing an intersection” may be realized by executing a recognition of an intersection by deep learning or the like and a recognition based on conditions (including pattern matching signals, road markings, and the like) given in advance in parallel and comprehensively evaluating both by scoring them. As a result, the reliability of automated driving is guaranteed.

The recognizer 130 recognizes states such as the position, speed and acceleration of the object in the vicinity of the host vehicle M on the basis of information input from the camera 10, the radar device 12, and the finder 14 via the object recognition device 16. The position of the object is, for example, recognized as a position on absolute coordinates having the origin at a representative point (a center of gravity, a center of a drive axis, or the like) of the host vehicle M, and is used for control. The position of the object may be represented by a representative point such as a center of gravity or a corner of the object, or may be represented by an expressed area. A “state” of the object may include the acceleration or jerk of the object, or an “action state” (for example, whether a lane is changed or is intended to be changed).

The recognizer 130 recognizes, for example, a lane (traveling lane) in which the host vehicle M is traveling. For example, the recognizer 130 recognizes a traveling lane by comparing a pattern (for example, an array of solid lines and dashed lines) of a road section line obtained from the second map information 62 with a pattern of a road section line in the vicinity of the host vehicle M recognized from an image captured by the camera 10. The recognizer 130 may recognize a traveling lane by recognizing not only a road section line but also a traveling road boundary (road boundary) including road section lines, road shoulders, curbs, median strips, guardrails, and the like. In this recognition, the position of the host vehicle M acquired from the navigation device 50 and a result of processing performed by the INS may be added. The recognizer 130 recognizes temporary stop lines, obstacles, red light, tollgates, or other road events.

When a traveling lane is recognized, the recognizer 130 recognizes the position and posture of the host vehicle M with respect to the traveling lane. The recognizer 130 may recognize, for example, a deviation of a reference point of the host vehicle M from a lane center and an angle formed with respect to a line connecting the lane centers in a traveling direction of the host vehicle M as the relative position and posture of the host vehicle M with respect to the traveling lane. Instead, the recognizer 130 may recognize a position and the like of the reference point of the host vehicle M with respect to either side end (a road section line or a road boundary) of the traveling lane as the relative position of the host vehicle M with respect to the traveling lane.

The recognizer 130 includes a parking space recognizer 132 that is started in an autonomous parking event to be described below. Details of functions of the parking space recognizer 132 will be described below.

In principle, the action plan generator 140 travels on a recommended lane determined by the recommended lane determiner 61, and furthermore, generates a target trajectory in which the host vehicle M will automatically (without depending on an operation of the driver) travel to be able to cope with the vicinity situation of the host vehicle M. The target trajectory includes, for example, a speed element. For example, the target trajectory is expressed as a sequence of points (orbit points) to be reached by the host vehicle M. The orbit points are points to be reached by the host vehicle M for each predetermined traveling distance (for example, about several [m]) in a road distance, and separately from this, a target speed and a target acceleration for each predetermined sampling time (for example, about 0 commas[sec]) are generated as a part of the target trajectory. The orbit points may be positions to be reached by the host vehicle M at a corresponding sampling time for each predetermined sampling time. In this case, the information on the target speed and the target acceleration is expressed by an interval between the orbit points.

The action plan generator 140 may set an automated driving event in generation of a target trajectory. Examples of the automated driving event include a constant-speed traveling event, a low-speed following traveling event, a lane change event, a branching event, a merging event, a takeover event, an autonomous parking event in which unmanned traveling or automated traveling is performed to park in valet parking and the like, and the like. The action plan generator 140 generates a target trajectory in accordance with a started event. The action plan generator 140 includes an autonomous parking controller 142 which is started when an autonomous parking event is executed. Details of functions of the autonomous parking controller 142 will be described below.

The second controller 160 controls the traveling drive force output device 200, the brake device 210, and the steering device 220 such that the host vehicle M passes through the target trajectory generated by the action plan generator 140 at a scheduled time.

Returning to FIG. 2, the second controller 160 includes, for example, an acquirer 162, a speed controller 164, and a steering controller 166. The acquirer 162 acquires information on the target trajectory (orbit points) generated by the action plan generator 140 and stores it in a memory (not shown). The speed controller 164 controls the traveling drive force output device 200 or the brake device 210 on the basis of a speed element associated with the target trajectory stored in the memory. The steering controller 166 controls the steering device 220 in accordance with a bending condition of the target trajectory stored in the memory. Processing of the speed controller 164 and the steering controller 166 is realized by, for example, a combination of feed forward control and feedback control. As an example, the steering controller 166 executes a combination of the feed forward control in accordance with curvature of a road in front of the host vehicle M and the feedback control based on a deviation from the target trajectory.

The traveling drive force output device 200 outputs a traveling drive force (torque) for a traveling of a vehicle to drive wheels. The traveling drive force output device 200 includes, for example, a combination of an internal combustion engine, an electric motor, a transmission, and the like, and an electronic control unit (ECU) that controls these. The ECU controls the constituents described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure to the cylinder, and a brake ECU. The brake ECU controls the electric motor according to the information input from the second controller 160 or the information input from the driving operator 80 such that a brake torque associated with a braking operation is output to each wheel. The brake device 210 may include, as a backup, a mechanism that transmits the hydraulic pressure generated by an operation of the brake pedal included in the driving operator 80 to the cylinder via a master cylinder. The brake device 210 is not limited to the configuration described above, and may be an electronically controlled hydraulic brake device that controls an actuator according to the information input from the second controller 160 and transmits the hydraulic pressure of the master cylinder to the cylinder.

The steering device 220 includes, for example, a steering ECU and an electric motor. The electric motor changes a direction of the steering wheel by, for example, applying a force to a rack and pinion mechanism. The steering ECU drives the electric motor and changes the direction of the steering wheel according to the information input from the second controller 160 or the information input from the driving operator 80.

### Autonomous Parking Event-at the Time of Entrance

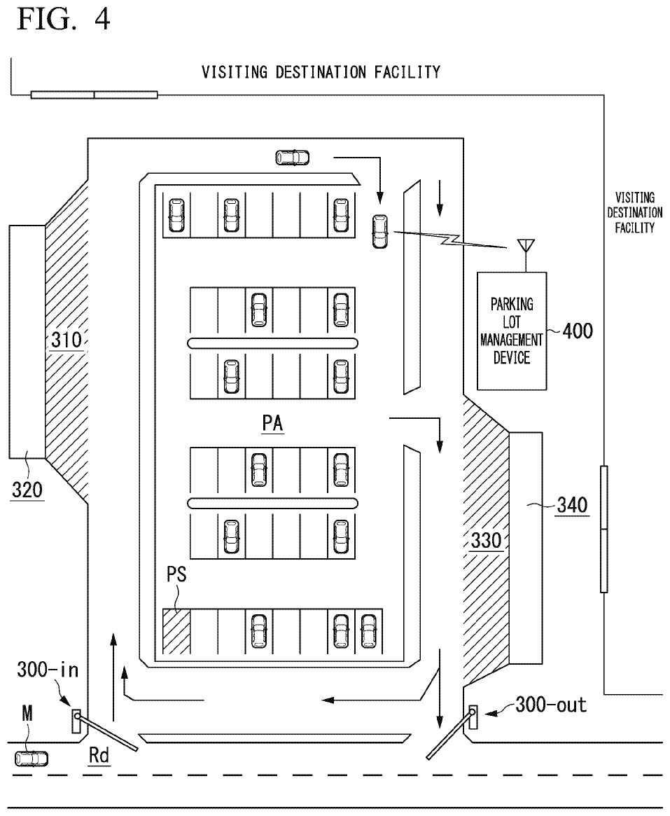

The autonomous parking controller 142 causes the host vehicle M to park in a parking space on the basis of, for example, information acquired from the parking lot management device 400 by the communication device 20. FIG. 4 is a diagram which schematically shows a scene in which an autonomous parking event is executed. In a route from a road Rd to a visiting destination facility, gates 300-in and 300-out are provided. The host vehicle M proceeds to a stop area 310 (or a stop area 330) by passing through the gate 300-in by manual driving or automated driving. The stop area 310 faces a getting-on/off area 320 (or a getting-on/off area 340) connected to the visiting destination facility. The getting-on/off area 320 is provided with an eave for avoiding rain and snow.

The host vehicle M starts an autonomous parking event in which unmanned automated driving and moving to a parking space PS in a parking lot PA are performed after the occupant is dropped at the stop area 310. A start trigger of the autonomous parking event may be, for example, certain operations performed by the occupant, or may be a reception of a predetermined signal wirelessly from the parking lot management device 400. The autonomous parking controller 142 controls the communication device 20 such that it transmits a parking request to the parking lot management device 400 when the autonomous parking event is started. Then, the host vehicle M moves from the stop area 310 to the parking lot PA according to a guidance of the parking lot management device 400 or while performing sensing by itself.

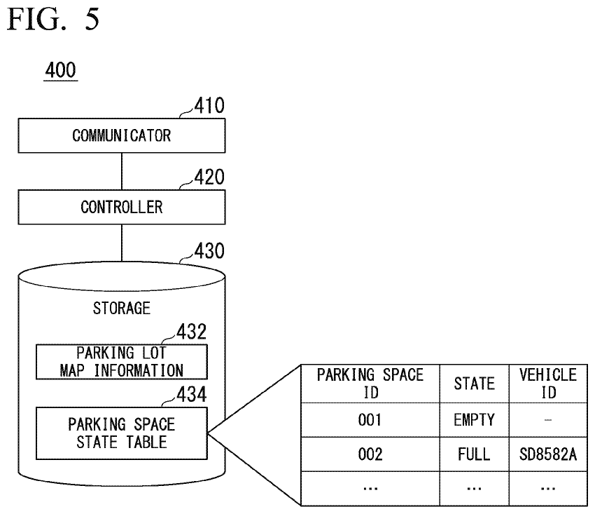

FIG. 5 is a diagram which shows an example of a configuration of the parking lot management device 400. The parking lot management device 400 includes, for example, a communicator 410, a controller 420, and a storage 430. The storage 430 stores parking lot map information 432 and information on a parking space state table 434 and the like.

The communicator 410 wirelessly communicates with the host vehicle M and other vehicles. The controller 420 guides a vehicle to the parking space PS on the basis of information acquired by the communicator 410 and information stored in the storage 430. The parking lot map information 432 is information in which a structure of the parking lot PA is geometrically represented. The parking lot map information 432 includes coordinates for each parking space PS. The parking space state table 434 includes, for example, a state indicating that a parking space is in an empty state or in a full (parking) state, and a vehicle ID that is identification information of a parking vehicle when a parking space is in the full state in association with a parking space ID that is identification information of the parking space PS.

If the communicator 410 receives the parking request from a vehicle, the controller 420 extracts a parking space PS which is in the empty state with reference to the parking space state table 434, acquires a position of the extracted parking space PS from the parking lot map information 432, and transmits a preferred route to the position of the acquired parking space PS to the vehicle using the communicator 410. The controller 420 instructs a specific vehicle to stop or slow down when necessary on the basis of a positional relationship of a plurality of vehicles such that vehicles do not proceed to the same position at the same time.

In the vehicle that has received the route (hereinafter, referred to as the host vehicle M), the autonomous parking controller 142 generates a target trajectory based on the route. If a target parking space PS is approached, the parking space recognizer 132 recognizes a parking frame line or the like that partitions the parking space PS, and recognizes a detailed position of the parking space PS to provide it to the autonomous parking controller 142. The autonomous parking controller 142 corrects the target trajectory after receiving this and causes the host vehicle M to park in the parking space PS.

### Autonomous Parking Event-at the Time of Exit

The autonomous parking controller 142 and the communication device 20 maintain an operating state even while the host vehicle M parks. The autonomous parking controller 142 causes a system of the host vehicle M to start and causes the host vehicle M to move to the stop area 310, for example, when the communication device 20 receives a pick-up request from a terminal device of the occupant. At this time, the autonomous parking controller 142 controls the communication device 20 such that it transmits a take-off request to the parking lot management device 400. The controller 420 of the parking lot management device 400 instructs a specific vehicle to stop or slow down when necessary on the basis of the positional relationship of a plurality of vehicles such that the vehicles do not proceed to the same position at the same time just like at the time of entrance. If the host vehicle M is moved to the stop area 310 to allow the occupant to board, the autonomous parking controller 142 stops operating, and thereafter, manual driving or automated driving performed by another functional part is started.

The autonomous parking controller 142 is not limited to the description above, and may find a parking space in the empty state by itself on the basis of a result of detection performed by the camera 10, the radar device 12, the finder 14, or the object recognition device 16 independently of communication, and cause the host vehicle M to park in the found parking space.

### Reservation Management Device

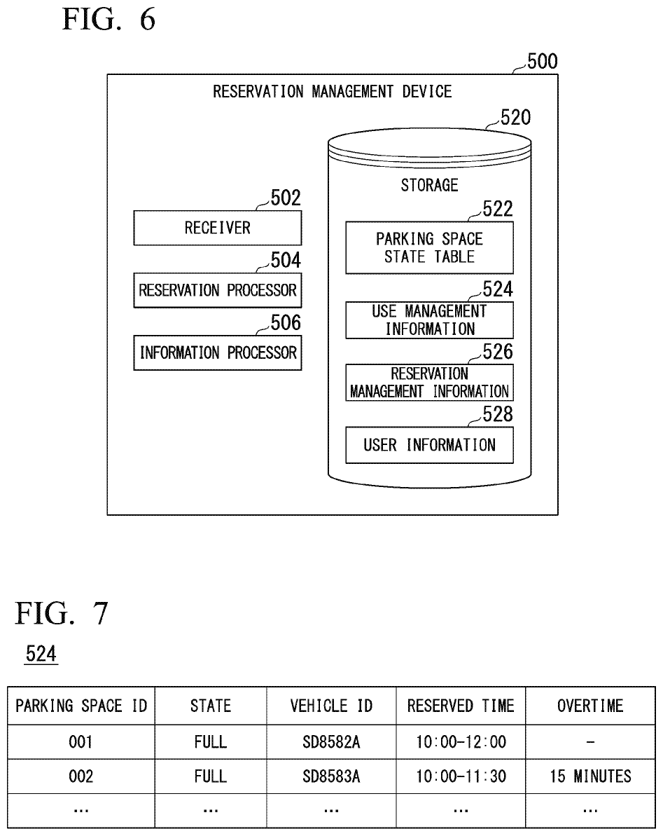

FIG. 6 is a diagram which shows an example of a functional configuration of the reservation management device 500. The reservation management device 500 includes, for example, a receiver 502, a reservation processor 504, an information processor 506, and a storage 520. The receiver 502 receives reservation information on the basis of an operation of a user, in which vehicle identification of a vehicle scheduled to park in a parking lot is associated with a parking start time at which the vehicle scheduled to park will start parking.

The reservation processor 504 manages the reservation information transmitted by the terminal device 600. The information processor 506 refers to permission information in which identification information of a parking vehicle parking in the parking lot is associated with time for which the parking vehicle is permitted to park in the parking lot and reservation information, and gives a penalty to a user of the parking vehicle when the parking vehicle has parked in the parking lot beyond the time in a state in which a reservation of the vehicle scheduled to park is present. For example, the information processor 506 gives a penalty to the user of the parking vehicle when the vehicle scheduled to park cannot park in the parking lot at the parking start time because the parking vehicle has parked in the parking lot beyond the time on the basis of a result of the reference described above. Details of this processing will be described below.

The storage 520 includes, for example, a parking space state table 522, use management information 524, reservation management information 526 (reservation information), and user information 528 (permission information). The parking space state table 522 is information the same as the parking space state table 434. The parking space state table 522 is information provided by the parking lot management device 400.

The use management information 524 is information in which, in addition to information included in the parking space state table 522, furthermore, a reserved time and an excess time of a vehicle are associated with each other. An excess time is a time by which the vehicle has parked beyond the reserved time. FIG. 7 is a diagram which shows an example of content of the use management information 524. The use management information 524 is information generated by the information processor 506. The information processor 506 refers to the parking space state table 522 and the use management information 524, identifies a vehicle having parked in the parking lot beyond the reserved time, and identifies a difference between a current time and the reserved time for the identified vehicle as overtime.

The reservation management information 526 and the user information 528 will be described below.

### Reservation Processing

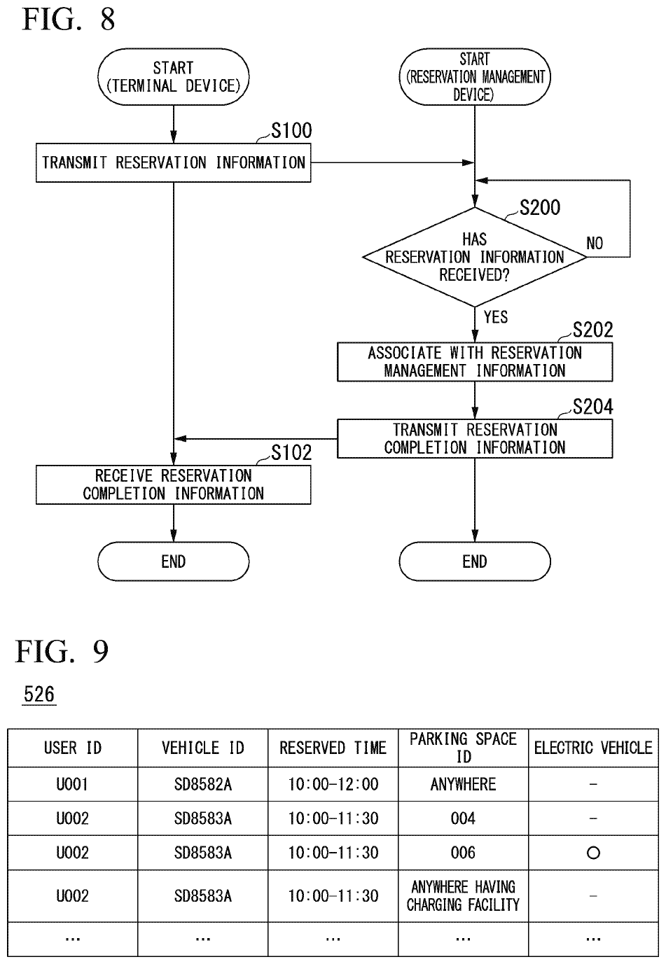

FIG. 8 is a flowchart which shows an example of a flow of processing executed by the reservation management device 500 and the terminal device 600. First, the terminal device 600 transmits the reservation information to the reservation management device 500 (step S100). If the reservation information transmitted by the terminal device 600 is received (step S200), the reservation management device 500 associates the reservation information with the reservation management information 526 (step S202). To associate means that the reservation information transmitted is stored as one record in the reservation management information 526 in the storage 520.

FIG. 9 is a diagram which shows an example of content of the reservation management information 526. The reservation management information 526 is information in which a user ID, a vehicle ID, reserved time, a parking space ID and a vehicle type are associated with each other. The parking space ID in the reservation management information 526 is a vehicle parking space designated by a user. The vehicle type is a type of a vehicle that the user parks. The vehicle type is, for example, an electric vehicle that can be charged using a charging facility or a vehicle other than the electric vehicle. The vehicle type may be a vehicle type (bus or ordinary car), a vehicle size, or the like.

Next, the reservation management device 500 transmits reservation completion information indicating that reservation has been completed to the terminal device 600 (step S204). Next, the terminal device 600 receives the reservation completion information transmitted by the reservation management device 500 (step S102). As a result, processing of this flowchart ends.

As described above, the user can reserve a parking lot for parking the host vehicle M by operating the terminal device 600.

### Reservation Management Processing

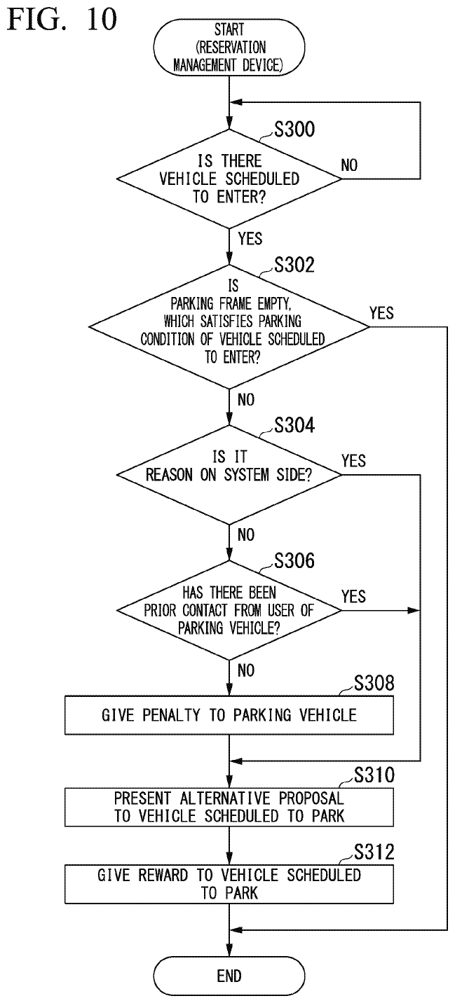

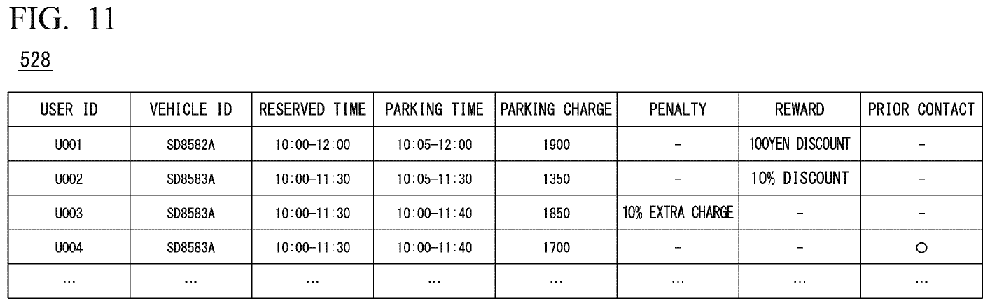

FIG. 10 is a flowchart which shows an example of a flow of processing executed by the reservation management device 500. Processing of this flowchart is started at predetermined time intervals (for example, every 5 minutes or 10 minutes). It may be started every start time of reserved time.

First, the reservation management device 500 refers to the reservation management information 526 and determines whether there is a vehicle scheduled to enter near a current time (step S300). When there is a vehicle scheduled to enter near the current time, the reservation management device 500 determines whether a parking frame that satisfies parking conditions of the vehicle scheduled to enter is empty (step S302). When the parking frame that satisfies the parking conditions of the vehicle scheduled to enter is empty, processing of this flowchart ends. In this case, the parking reserved vehicle can park in the reserved parking space.

When the parking frame that satisfies the parking conditions of the vehicle scheduled to enter is not empty, the reservation management device 500 determines whether a reason why the parking frame is not empty is a reason on a system side (step S304). The reason on the system side is that the parking reserved vehicle cannot park in the parking lot because the reservation management device 500 has performed overbooking by predicting that there will be a user who will cancel a reservation. The reason on the system side is that a vehicle scheduled to exit cannot exit, a vehicle scheduled to enter cannot enter, or the like due to a delay in the processing of the reservation management device 500, a system failure of the reservation management device 500, a system failure in the parking lot management system 1, or the like. When the reason is the reason on the system side, the procedure proceeds to processing of step S310.

When there is no reason on the system side, the reservation management device 500 refers to the user information 528 and determines whether there has been a prior contact from the user of the parking vehicle (step S306). The prior contact is a contact indicating that an exit of the parking vehicle will exceed the reserved time. When there has been a prior contact from the user of the parking vehicle, the procedure proceeds to the processing of step S310. For example, if the user transmits information indicating that an exit will be delayed to the reservation management device 500 by operating the terminal device 600, the reservation management device 500 acquires the information transmitted by the terminal device 600 and associates the acquired information with a user ID of the user information 528.

FIG. 11 is a diagram which shows an example of content of the user information 528. The user information 528 is, for example, information in which a user ID, a vehicle ID, a reserved time (permitted time), a parking time, a parking fee, a penalty, a reward, and a presence or absence of prior contact are associated with each other. The reward guarantees, for example, a profit received by a user of a vehicle scheduled to park and a disadvantage received by a user of a vehicle scheduled to park. In other words, the “reward” can be referred to as, for example, a compensation for a loss, a price, a compensation, a repayment, collateral, or the like for a disadvantage. The parking charge is a charge including a penalty or a reward. The reservation management device 500 refers to the user information 528 and determines whether there has been a prior contact.

The information processor 506 of the reservation management device 500 may provide a terminal device of the user of the parking vehicle with information indicating that the parking end time is approaching predetermined time before the end time of the permitted time for parking. That is, the information processor 506 may make an inquiry to the user of the parking vehicle before the reserved parking time ends. The inquiry is an inquiry about whether the vehicle can exit at the reserved parking time. In response to the inquiry, when there has been a reply indicating that there will be overtime for parking from the user of the parking vehicle, it may be considered that there has been a prior contact.

As described above, in a case in which the vehicle scheduled to park cannot park in the parking lot at the parking start time, the reservation management device 500 does not give a penalty to the user of the parking vehicle when it has acquired information indicating that the parking vehicle will park in the parking lot beyond the parking reserved time from the user of the parking vehicle before the parking reserved time of the parking vehicle elapses. This alleviates an excessive burden on the user.

In the processing of step S304, the reservation management device 500 may proceed to the processing of step S310 when it is determined that the vehicle scheduled to park cannot park in the parking lot due to a reason not caused by the parking vehicle. The reason not caused by the parking vehicle includes maintenance of a parking space, maintenance of the parking lot, or the like as well as overbooking, a system failure, or the like as described above.

When there is no prior contact from the user of the parking vehicle, the reservation management device 500 gives a penalty to the user of the vehicle parking in the parking lot beyond the reserved time (step S308). The penalty is a burden of exceeding the reserved time. The penalty is, for example, a charge rate for parking per unit time in overtime set higher than the charge rate for parking per unit time in reserved time, a charge including a separate charge from the parking charge, or the like.

The information processor 506 derives, for example, a given penalty on the basis of the overtime, and associates the derived penalty with a record associated with a vehicle ID of the parking-time exceeding vehicle of the user information 528. The information processor 506 derives a parking charge on the basis of the associated penalty and the parking time of the vehicle, and updates the parking charge associated with the record with the derived parking charge.

Next, the reservation management device 500 presents an alternative proposal to the vehicle scheduled to park (step S310). Details of the alternative proposal will be described below. Next, the reservation management device 500 gives a reward to the vehicle scheduled to park (step S312). That is, the information processor 506 gives a reward to the vehicle scheduled to park when the vehicle scheduled to park cannot park in the parking lot at the parking start time. For example, the information processor 506 gives a reward to the user of the vehicle scheduled to park when the vehicle scheduled to park cannot park in the parking lot due to reasons caused by parking of a parking vehicle or not caused by the parking vehicle.

The reward is a charge rate per unit time set lower than the charge rate when the vehicle can park during the reserved time, or a predetermined amount being discounted from a total amount of the parking charge. A degree of the discount increases, for example, as a difference between a time at which the vehicle scheduled to park enters the parking lot and the reservation start time increases due to a reason on a system side, parking of another vehicle, or the like. The reward may be a coupon or the like that can be used at a predetermined store or parking lot in addition to the discount described above. As a result, processing of this flowchart ends.

For example, when the vehicle scheduled to park cannot park in a parking-scheduled parking space, the information processor 506 derives the given reward and associates the derived reward with a record associated with the vehicle ID of the vehicle scheduled to park of the user information 528. The information processor 506 derives a parking charge on the basis of the associated reward and parking time of the vehicle, and associates the derived parking charge with the record after the vehicle scheduled to park has used the parking lot.

According to the processing described above, the reservation management device 500 can improve an operation efficiency of the parking lot. For example, a parking vehicle exiting within a scheduled parking time is promoted. This improves a certainty that the vehicle scheduled to park can park at a scheduled parking time. In this manner, the reservation management device 500 can improve the operation efficiency of the parking lot. Even if the vehicle scheduled to park cannot park at the scheduled parking time, since the user of the vehicle scheduled to park is given a reward, a satisfaction of the user is improved or a sense of agreement thereof is improved.

### Alternative Proposal (1)

For example, the reservation management device 500 receives a reservation of a first parking space that is equipped with the charging facility on the basis of a request of a user and receives a reservation of a second parking space that is not equipped with the charging facility when there is no request of the user. Due to the circumstances described above, when the second parking space that is not equipped with the charging facility is full and the vehicle scheduled to park cannot park in the second parking space, the reservation management device 500 may cause the vehicle scheduled to park to park in the first parking space if the first parking space is empty. In this case, the reservation management device 500 transmits information indicating that parking is temporarily permitted in the first parking space to the parking lot management device 400. Then, the parking lot management device 400 communicates with the vehicle and causes the vehicle to park in the first parking space.

In this case, the reservation management device 500 refers to the reservation management information 526, and, when the vehicle scheduled to park is an electric vehicle, it may control the charging facility such that the vehicle scheduled to park can be charged using the charging facility of the parking space in which the vehicle scheduled to park parks. That is, the reservation management device 500 allows use of the charging facility. When an electric vehicle parks in a parking space equipped with the charging facility, charging is performed by a clerk connecting a charging cable of the charging facility to the electric vehicle or the charging facility performing wireless power supply on the electric vehicle. As a result, the electric vehicle can park in the first parking space and get charged for free or at a discounted charge.

As described above, when the vehicle scheduled to park cannot park in the parking lot at the parking start time, the reservation management device 500 instructs the vehicle scheduled to park to park in a parking space for electric vehicles, which is equipped with a charging facility. As a result, the vehicle scheduled to park can park in the first parking space even though there is no empty space in the second parking space.

The reservation management device 500 refers to information on the vehicle scheduled to park with which a type of the vehicle scheduled to park is associated when parking in the first parking space for electric vehicles is instructed, and allows the vehicle scheduled to park to use the charging facility for free when the vehicle scheduled to park is an electric vehicle. As a result, the satisfaction of the user of the vehicle scheduled to park is improved. The use of the charging facility is an example of the reward.

### Alternative Proposal (2)

For example, the reservation management device 500 acquires availabilities of parking lots adjacent to the parking lot in which the vehicle scheduled to park parks from an information providing server (not shown). Then, when there is an empty space in an adjacent parking lot, the reservation management device 500 guides the vehicle scheduled to park to a parking lot with an empty space. In this case, a charge for using the adjacent parking lot of the vehicle scheduled to park may be charged upon an administrator of the reservation management device 500.

As described above, even if there is no empty space in a parking space, the vehicle scheduled to park can park in an adjacent parking lot. As a result, the sense of agreement of the user is improved.

### Alternative Proposal (3)

For example, the reservation management device 500 may instruct the vehicle scheduled to park to wait at a temporary standby position or instruct the vehicle to travel on a predetermined route (for example, a route within a facility or a route adjacent to the facility). In this case, the reservation management device 500 may inquire the user of a vehicle parking beyond scheduled time of scheduled exit time, and determine content of the instruction to the vehicle scheduled to park on the basis of a result of the inquiry. For example, when the exit time is within a predetermined time, the reservation management device 500 may cause the vehicle scheduled to park to stop at the temporary standby position. As a result, the vehicle scheduled to park can quickly park in a parking space after the parking space becomes available.

Content of the reward or penalty may be changed according to a degree of congestion related to a use of the parking lot. For example, the reservation management device 500 may set the reward higher and set the penalty higher when the degree of congestion is high or it is a peak season. For example, the reservation management device 500 may set the reward lower and set the penalty lower when the degree of congestion is low or it is an off-peak season.

Regarding the processing of giving a penalty to the user of the parking vehicle when the vehicle scheduled to park cannot park in the parking lot at the parking start time because the parking vehicle has parked in the parking lot beyond the time, it is described in the embodiment described above that a penalty is given to the user of the parking vehicle “when a parking frame satisfying the parking conditions of a vehicle scheduled to enter is not empty.” Instead of (or in addition to) this, the reservation management device 500 may give a penalty to the user of the parking vehicle “when the vehicle scheduled to enter cannot park in a reserved parking lot due to predetermined circumstances (such as the parking lot being full).” For example, in a case in which there is a parking vehicle having parked beyond its time, and a vehicle scheduled to park is scheduled to park in a parking space in which the parking vehicle has parked, when the vehicle scheduled to park can park in another parking space, a penalty may or may not be imposed on the parking vehicle, and a reward may or may not be imposed on the vehicle scheduled to park.

For example, in a case in which the parking space is a specific parking space, a penalty may be given to a user of the parking vehicle “when a specific space designated by a user of the vehicle scheduled to enter is not empty.” In this case, a second penalty whose burden is larger than a first penalty may be given to the user of the parking vehicle that has parked beyond its time. The first penalty is a penalty given to the user of the parking vehicle that has parked beyond its time when the vehicle scheduled to park that a specific parking space does not be designated cannot park in the designated parking space. The specific parking space is a parking space that has a larger space than a normal parking space (for example, a parking space available for a vehicle whose width is larger than normal, a vehicle whose length is longer than normal, or a vehicle whose height is higher than normal) or a parking space provided with a charging facility.

According to the embodiment described above, the reservation management device 500 receives reservation information in which the vehicle identification of a vehicle scheduled to park in a parking lot is associated with a parking start time at which the vehicle scheduled to park starts parking on the basis of an operation of a user, refers to permission information in which the identification information of a parking vehicle parking in the parking lot is associated with time for which the parking vehicle is permitted to park in the parking lot, and the reservation information, and gives a penalty to a user of the parking vehicle when the parking vehicle has parked in the parking lot beyond permitted time in a state in which a reservation of the vehicle scheduled to park is present, thereby improving the operation efficiency of the parking lot.

### Hardware Configuration

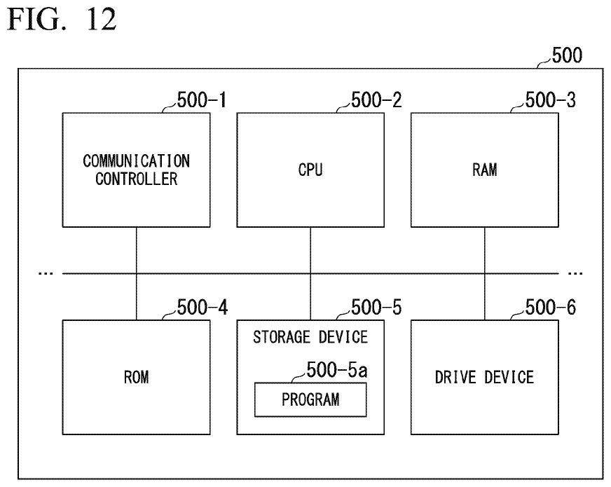

FIG. 12 is a diagram which shows an example of a hardware configuration of the reservation management device 500 of the embodiment.

As shown in the drawings, the reservation management device 500 is configured to include a communication controller 500-1, a CPU 500-2, a random access memory (RAM) 500-3 used as a working memory, and a read only memory (ROM) 500-4 that stores a booting program and the like, a storage device 500-5 such as a flash memory or a hard disk drive (HDD), a drive device 500-6, and the like being connected to each other by an internal bus or a dedicated communication line. The communication controller 500-1 communicates with components other than the reservation management device 500. The storage device 500-5 stores a program 500-5a executed by the CPU 500-2. This program is developed in the RAM 500-3 by a direction memory access (DMA) controller (not shown) or the like, and is executed by the CPU 500-2. Accordingly, some or all of the receiver 502, the reservation processor 504, and the information processor 506 are realized. The parking lot management device 400, similarly to the above description, is configured to include a communication controller, a CPU, a RAM, a ROM, a storage device, a drive device, and the like being connected to each other by an internal bus or a dedicated communication line. Then, the program stored in the storage device is executed by the CPU, and thereby the controller 420 performs various types of processing. The automated driving control device 100, similarly to the above description, is also configured to include a communication controller, a CPU, a RAM, a ROM, a storage device, a drive device, and the like being connected to each other by an internal bus or a dedicated communication line. The program stored in the storage device is executed by the CPU, and thereby some or all of the recognizer 130, the action plan generator 140, and the second controller are realized.

The embodiments described above can be expressed as follows.

A vehicle control device includes a storage device that stores a program, and a hardware processor, the hardware processor executes a program stored in the storage device, thereby receiving reservation information in which vehicle identification of a vehicle scheduled to park in a parking lot is associated with a parking start time at which the vehicle scheduled to park starts parking on the basis of an operation of a user, referring to permission information in which identification information of a parking vehicle parking in the parking lot is associated with time for which the parking vehicle is permitted to park in the parking lot, and the reservation information, and giving a penalty to a user of the parking vehicle when the parking vehicle has parked in the parking lot beyond the time in a state in which a reservation of the vehicle scheduled to park is present.

As described above, the forms for implementing the present invention have been described using the embodiments. However, the present invention is not limited to such embodiments, and various modifications and substitutions may be added in a range not departing from the gist of the present invention.

What is claimed is:

1. A management device comprising:
a receiver configured to receive reservation information, on the basis of an operation of a user, in which vehicle identification of a vehicle scheduled to park in a parking lot is associated with a parking start time at which the vehicle scheduled to park will start parking; and
an information processor configured to refer to permission information in which identification information of a parking vehicle parking in the parking lot is associated with a time for which the parking vehicle is permitted to park in the parking lot, and the reservation information, and to give a penalty to a user of the parking vehicle when the parking vehicle has parked in the parking lot beyond the time in a state in which a reservation of the vehicle scheduled to park is present.

2. The management device according to claim 1,
wherein the parking lot is a parking lot in which the parking vehicle and the vehicle scheduled to park are permitted to park using autonomous entrance or to exit from the parking lot using autonomous exit.

3. The management device according to claim 1,
wherein the information processor is configured to give a reward to a user of the vehicle scheduled to park when the vehicle scheduled to park cannot park in the parking lot at the parking start time.

4. The management device according to claim 1,
wherein, when the vehicle scheduled to park cannot park in the parking lot at the parking start time, the information processor is configured to instruct the vehicle scheduled to park to park in a parking space for electric vehicles, which is equipped with a charging facility.

5. The management device according to claim 4,
wherein, when the vehicle scheduled to park is instructed to park in the parking space for electric vehicles, the information processor is configured to refer to information regarding the vehicle scheduled to park with which a type of the vehicle scheduled to park is associated, and allows the vehicle scheduled to park to use the charging facility for free when the vehicle scheduled to park is an electric vehicle.

6. The management device according to claim 1,
wherein, when the vehicle scheduled to park cannot park in the parking lot at the parking start time, the information processor does not give a penalty to the user of the parking vehicle when information indicating that the parking vehicle will park in the parking lot beyond the permitted time is acquired before the permitted time elapses.

7. The management device according to claim 1,
wherein the information processor provides a terminal device of the user of the parking vehicle with information indicating that an end time is approaching predetermined time before the end time of the permitted time for parking.

8. The management device according to claim 1,
wherein the information processor is configured to give a reward to the user of the vehicle scheduled to park when the vehicle scheduled to park cannot park in the parking lot due to a reason not caused by the parking vehicle.

9. The management device according to claim 8,
wherein the reason not caused by the parking vehicle is that the management device has received parking reservations from a larger number of vehicles than the number of vehicles that are acceptable by the parking lot at a time at which the vehicle scheduled to park starts parking, or is a defect of the management device.

10. A management method comprising:
by a computer,
receiving reservation information, on the basis of an operation of a user, in which vehicle identification of a vehicle scheduled to park in a parking lot is associated with a parking start time at which the vehicle scheduled to park starts parking;
referring to permission information in which identification information of a parking vehicle parking in the parking lot is associated with time for which the parking vehicle is permitted to park in the parking lot, and the reservation information; and
giving a penalty to a user of the parking vehicle when the parking vehicle has parked in the parking lot beyond the time in a state in which a reservation of the vehicle scheduled to park is present.

11. A non-transitory computer-readable storage medium that stores a computer program to be executed by a computer to perform at least:
receive reservation information, on the basis of an operation of a user, in which vehicle identification of a vehicle scheduled to park in a parking lot is associated with a parking start time at which the vehicle scheduled to park starts parking;
refer to permission information in which identification information of a parking vehicle parking in the parking lot is associated with time for which the parking vehicle is permitted to park in the parking lot, and the reservation information; and
give a penalty to a user of the parking vehicle when the parking vehicle has parked in the parking lot beyond the time in a state in which a reservation of the vehicle scheduled to park is present.
